(19) United States
(12) Patent Application Publication
(10) Pub. No.: US 2026/0082460 A1
(43) Pub. Date: Mar. 19, 2026

(54) MEASURING DEVICE FOR A COOKING APPLIANCE

(71) Applicant: Haier US Appliance Solutions, Inc., Wilmington, DE (US)

(72) Inventor: Bagawathkumar Chellappan, Prospect, KY (US)

(21) Appl. No.: 18/889,996

(22) Filed: Sep. 19, 2024

(51) Int. Cl. H05B 6/64; A47J 36/32; A47J 37/06; G01F 23/2962

(52) U.S. Cl. CPC H05B 6/6467; A47J 36/321; A47J 37/0629; A47J 37/0664; G01F 23/2962; H05B 6/645

(57) ABSTRACT

A measuring device for a cooking appliance includes a first sensor configured to measure one or more parameters associated with a heating operation of the cooking appliance. Furthermore, the measuring device includes a second sensor configured as a fluid sensor. The fluid sensor is configured to measure one or more parameters associated with a presence or level of a fluid within a food container. The food container is configured for heating by the cooking appliance.

### FIELD OF THE INVENTION

The present subject matter relates generally to cooking appliances, and more particularly to measuring devices for cooking appliances.

### BACKGROUND OF THE INVENTION

Cooking appliances, such as microwave appliances, may be used by consumers to perform tasks such as heating or cooking food. Generally, microwave appliances include a cabinet that defines a cooking chamber for receipt of food items for cooking. In order to provide selective access to the cooking chamber and to contain food items and cooking energy (e.g., microwaves) during a cooking operation, a door is further included that is typically pivotally mounted to the cabinet. During use, a magnetron may generate microwave radiation or microwaves that are emitted and directed specifically to the cooking chamber. The microwave radiation is typically able to heat and cook food items within the cooking chamber faster than would be possible with conventional cooking methods using direct or indirect heating methods. Moreover, since microwave appliances are often smaller than other appliances (e.g., a conventional baking oven) within a kitchen, microwave appliances are often preferable for heating relatively small portions or amounts of food.

Sometimes, the microwaves emitted by the microwave appliance can disrupt the functioning of electronic components, such as thermometers or other temperature measuring devices, that are inserted within the cooking chamber of the microwave appliance.

Accordingly, a measuring device for a cooking appliance would be desirable. More specifically, a measuring device for a cooking appliance that is protected from electromagnetic emissions by the cooking appliance would be particularly beneficial.

### BRIEF DESCRIPTION OF THE INVENTION

Aspects and advantages of the invention will be set forth in part in the following description, or may be obvious from the description, or may be learned through practice of the invention.

In one example aspect of the present disclosure, a measuring device for a cooking appliance is provided. The measuring device includes a housing. The housing is configured to house one or more internal electronic components of the measuring device. Additionally, the measuring device includes an ultrasonic fluid sensor. The ultrasonic fluid sensor is positioned on or within the housing. Furthermore, the ultrasonic fluid sensor is configured to emit sound waves at fluid within a food container. Moreover, the ultrasonic fluid sensor is configured to analyze a speed of reflected sound waves. The food container is configured for heating by the cooking appliance. Additionally, the speed of the reflected sound waves is indicative of a presence or a level of the fluid within the food container.

In another example aspect of the present disclosure, a measuring device for a cooking appliance is provided. The measuring device includes a housing configured to house one or more internal electronic components of the measuring device. Additionally, the measuring device includes a first sensor positioned within the housing. The first sensor is configured to measure one or more parameters associated with a heating operation of the cooking appliance. Additionally, the first sensor is at least partially submerged in fluid within a food container. Furthermore, the measuring device includes a second sensor configured as a fluid sensor. The fluid sensor is positioned on or within the housing. Moreover, the fluid sensor is configured to measure one or more parameters associated with a presence or level of the fluid within the food container. The food container is configured for heating by the cooking appliance.

In another example aspect of the present disclosure, a measuring device for a cooking appliance is provided. The measuring device includes a first sensor. The first sensor is configured to measure one or more parameters associated with a heating operation of the cooking appliance. Additionally, the first sensor is at least partially submerged in fluid within a food container. Furthermore, the measuring device includes a second sensor configured as a fluid sensor. The fluid sensor is configured to measure one or more parameters associated with a presence or level of the fluid within the food container. The food container is configured for heating by the cooking appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a perspective view of the exemplary cooking appliance of FIG. 1, wherein the door is an open position.

FIG. 3 provides a sectional view of the exemplary cooking appliance of FIG. 2.

FIG. 4 provides a sectional view of an exemplary measuring device to be utilized with a cooking appliance according to exemplary embodiments of the present disclosure.

FIG. 5 provides a sectional view of a cooking container with the exemplary measuring device of FIG. 4 positioned within the cooking container.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

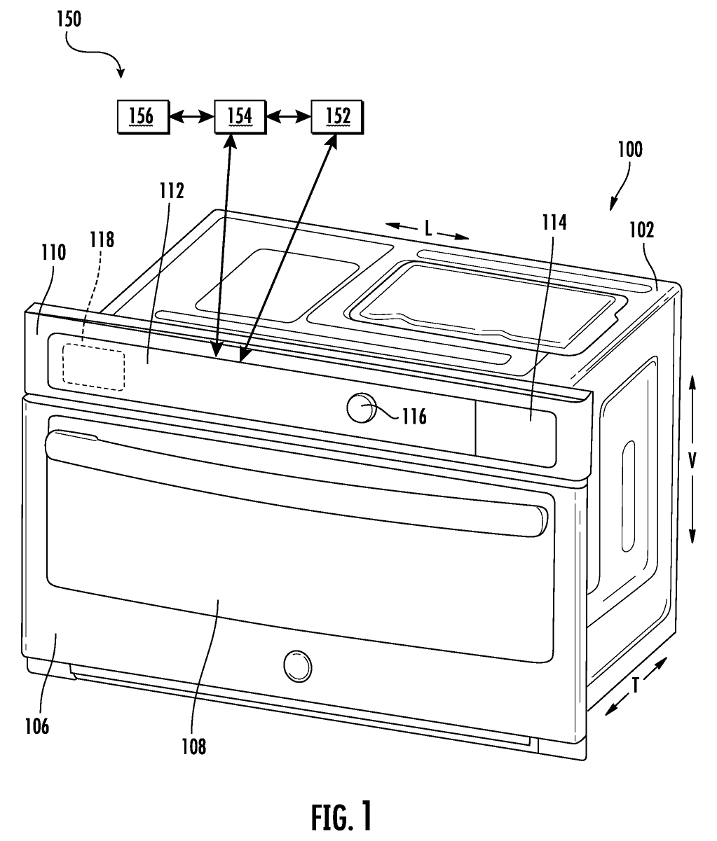

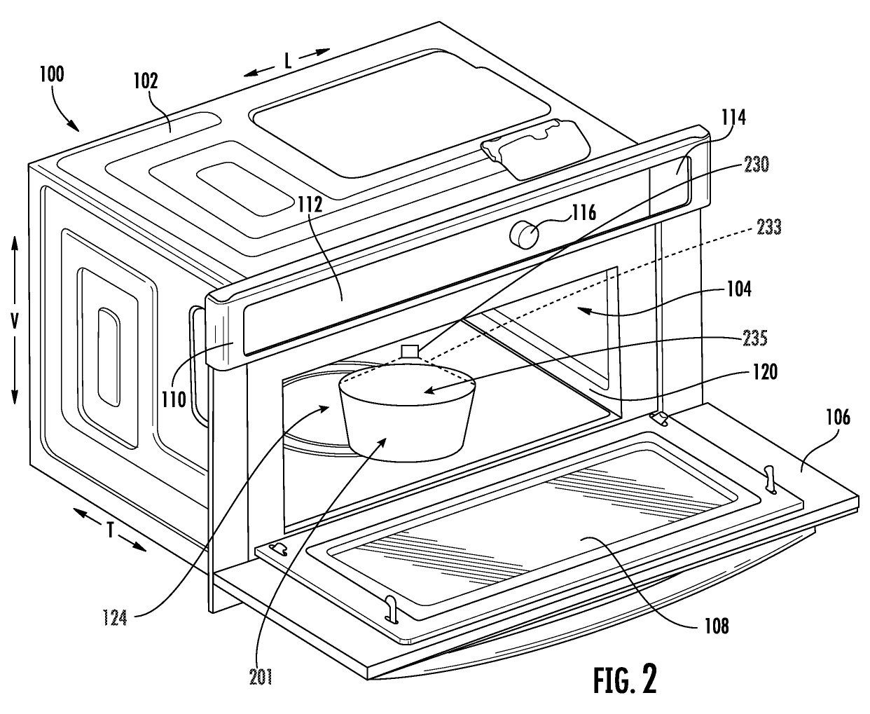

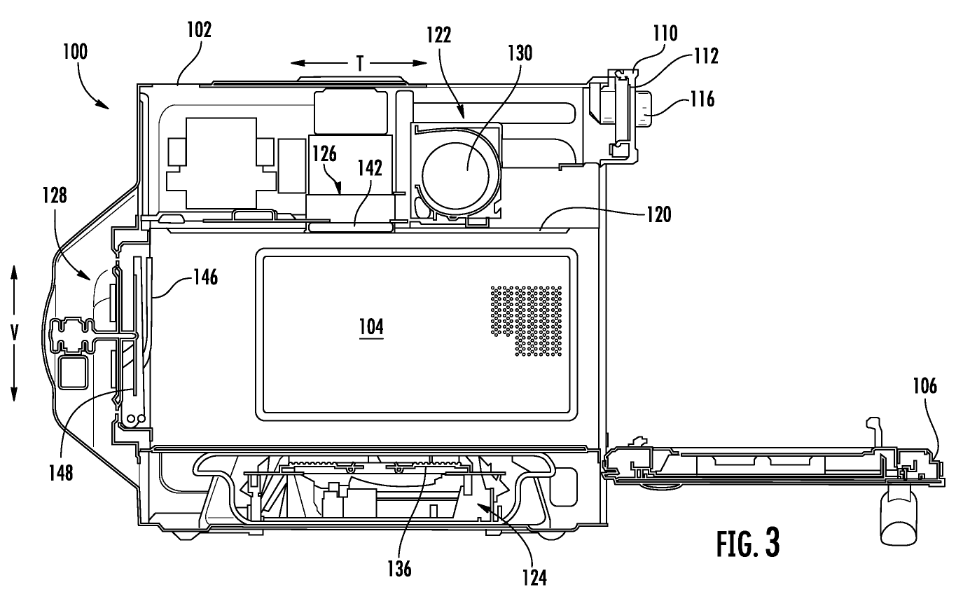

Referring to the figures, FIGS. 1 through 3 provide various views of a cooking appliance 100 according to exemplary embodiments of the present disclosure. Specifically, FIGS. 1 and 2 provide perspective views of cooking appliance 100 having a door 106 in an open position and a closed position, respectively. FIG. 3 provides a side, sectional view of cooking appliance 100, wherein door 106 is in the open position.

While described in the context of a specific embodiment of a microwave appliance, it should be appreciated that the cooking appliance 100 is provided by way of example only. It will be understood that aspects of the present subject matter may be used in any other suitable cooking appliance, such as a conventional oven or a convection oven, a toaster oven, an air fryer, and/or the like. Indeed, modifications and variations may be made to the cooking appliance 100, including different configurations, different appearances, and/or different features while remaining within the scope of the present subject matter.

Generally, cooking appliance 100 includes a housing or cabinet 102 that defines a mutually orthogonal vertical direction V, lateral direction L, and transverse direction T. Within cabinet 102, cooking appliance 100 defines a cooking chamber 104 in which food items may be received. In some embodiments, a door 106 is rotatably mounted to move between the open position and the closed position. As shown, the open position permits access to cooking chamber 104 while the closed position restricts access to cooking chamber 104. A window 108 in door 106 may be provided (e.g., for viewing food items in the cooking chamber 104). Additionally, or alternatively, a handle may be secured to door 106 (e.g., to rotate therewith). The handle may be formed of plastic, for example, and may be injection molded.

In certain embodiments, cooking appliance 100 includes a control panel frame 110 on or as part of cabinet 102. A control panel 112 may be mounted within control panel frame 110. Generally, control panel 112 includes a display device 114 for presenting various information to a user. For example, display device 114 may present various notifications to the user. Control panel 112 may also include one or more input devices (e.g., tactile buttons, knobs, touch screens, etc.) for selecting a desired mode of operation, such as a heating operation. Additionally, control panel 112 may also include one or more input devices for selecting various parameters associated with a mode of operation. For example, control panel 112 may include input devices for selecting a cooking time, a food content cooked temperature, and/or a cooking power level. In optional embodiments, the input devices of control panel 112 include a knob or dial 116. Selections may be made by rotating dial 116 clockwise or counterclockwise, and when the desired selection is displayed, pressing dial 116. For example, many meal cook cycles and other cooking algorithms may be preprogrammed in or loaded onto a memory device of a controller 118 of cooking appliance 100 for many different food item types (e.g., pizza, fried chicken, French fries, potatoes, etc.), including simultaneous preparation of a group of food items of different food types comprising an entire meal. Instructions or selections may be displayed on display device 114. In optional embodiments, display device 114 may be used as an input device. For instance, display device 114 may be a touchscreen device, as is understood.

In exemplary embodiments, cabinet 102 of cooking appliance 100 includes an inner shell 120. Inner shell 120 of cabinet 102 delineates the interior volume of cooking chamber 104. Optionally, the walls of shell may be constructed using high reflectivity (e.g., 72% reflectivity) stainless steel.

Cooking appliance 100 may include one or more cooking modules. In particular, cooking appliance 100 may include a microwave module 122. In some optional embodiments, cooking appliance 100 may include a lower heater module 124 mounted within cabinet 102. Additionally, or alternatively, in some optional embodiments, cooking appliance 100 may include an upper heater module 126 or a convection module 128.

Generally, microwave module 122 may include a magnetron 130 mounted within the cabinet 102 (e.g., above cooking chamber 104) and in communication (e.g., fluid or transmissive communication) with the cooking chamber 104 to emit or direct microwave radiation or microwaves thereto and/or within cooking chamber 104, such as during a heating operation of cooking appliance 100. In other words, the microwave module 122 delivers microwave radiation into cooking chamber 104.

Below microwave module 122, lower heater module 124 may be mounted within cabinet 102. For instance, lower heater module 124 may include a heating coil 136 mounted below cooking chamber 104. The heating coil 136 may be, e.g., an induction heating coil or a resistive heating coil. The heating coil 136 may be in communication (e.g., transmissive communication) with cooking chamber 104 for heating objects, e.g., food items and/or cooking utensils, positioned within the cooking chamber 104.

Upper heater module 126 may include one or more heating elements 142. For instance, upper heater module 126 may include one or more electric heating elements, such as a resistive heating element (e.g., sheathed resistive heater) or a radiant heating element (e.g., a halogen cooking lamp) in thermal communication with cooking chamber 104. Upper heater module 126 may be mounted within or above cooking chamber 104 or otherwise spaced apart from microwave module 122.

Convection module 128 may include a sheathed heater 146 and a convection fan 148. Convection fan 148 is provided for blowing or otherwise moving air over sheathed heater 146 of convection module 128 and into cooking chamber 104 (e.g., for convection cooking).

The specific heating elements of upper and lower heater modules 126 and 124, convection module 128, and magnetron 130 of microwave module 122 may vary from embodiment to embodiment, and the elements and system described above are exemplary only. For example, the upper heater module 126 or convection module 128 may include any combination of heaters including combinations of halogen lamps, ceramic lamps, or sheathed heaters.

As shown, cooking appliance 100 may include a controller 118. Controller 118 of cooking appliance 100 may include one or more processor(s) and one or more memory device(s). The processor(s) of controller 118 may be any suitable processing device, such as a microprocessor, microcontroller, integrated circuit, or other suitable processing device. The memory device(s) of controller 118 may include any suitable computing system or media, including, but not limited to, non-transitory computer-readable media, RAM, ROM, hard drives, flash drives, or other memory devices. The memory device(s) of controller 118 may store information accessible by the processor(s) of controller 118 including instructions that may be executed by the processor(s) of controller 118 in order to execute various cooking operations or cycles (e.g., a meal cook cycle). Controller 118 is communicatively coupled with various operational components of cooking appliance 100, such as components of microwave module 122, upper heater module 126, lower heater module 124, convection module 128, or control panel 112 (e.g., display device 114 or dial 116), the various control buttons, etc. Input/output (“I/O”) signals may be routed between controller 118 and control panel 112 as well as other operational components of cooking appliance 100. Controller 118 may execute and control cooking appliance 100 in various cooking operations or cycles, such as precision cooking, which includes meal cook, microwave, induction, or convection/bake modes.

Referring to FIG. 1, a schematic diagram of an external communication system 150 will be described according to an exemplary embodiment of the present subject matter. In general, external communication system 150 is configured for permitting interaction, data transfer, and other communications between cooking appliance 100 and one or more external devices. For example, this communication may be used to provide and receive operating parameters, user instructions or notifications, performance characteristics, user preferences, or any other suitable information for improved performance of cooking appliance 100. In addition, it should be appreciated that external communication system 150 may be used to transfer data or other information to improve performance of one or more external devices or appliances and/or improve user interaction with such devices.

For example, external communication system 150 permits controller 118 of cooking appliance 100 to communicate with a separate device external to cooking appliance 100, referred to generally herein as an external device 152. As described in more detail below, these communications may be facilitated using a wired or wireless connection, such as via a network 154. In general, external device 152 may be any suitable device separate from cooking appliance 100 that is configured to provide and/or receive communications, information, data, or commands from a user. In this regard, external device 152 may be, for example, a personal phone, a smartphone, a tablet, a laptop or personal computer, a wearable device, a smart home system, or another mobile or remote device.

In addition, a remote server 156 may be in communication with cooking appliance 100 and/or external device 152 through network 154. In this regard, for example, remote server 156 may be a cloud-based server 156, and is thus located at a distant location, such as in a separate state, country, etc. According to an exemplary embodiment, external device 152 may communicate with a remote server 156 over network 154, such as the Internet, to transmit/receive data or information, provide user inputs, receive user notifications or instructions, interact with or control cooking appliance 100, etc. In addition, external device 152 and remote server 156 may communicate with cooking appliance 100 to communicate similar information.

In general, communication between cooking appliance 100, external device 152, remote server 156, and/or other user devices or appliances may be carried using any type of wired or wireless connection and using any suitable type of communication network, non-limiting examples of which are provided below. For example, external device 152 may be in direct or indirect communication with cooking appliance 100 through any suitable wired or wireless communication connections or interfaces, such as network 154. For example, network 154 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 150 is described herein according to an exemplary embodiment of the present subject matter. However, it should be appreciated that the exemplary functions and configurations of external communication system 150 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

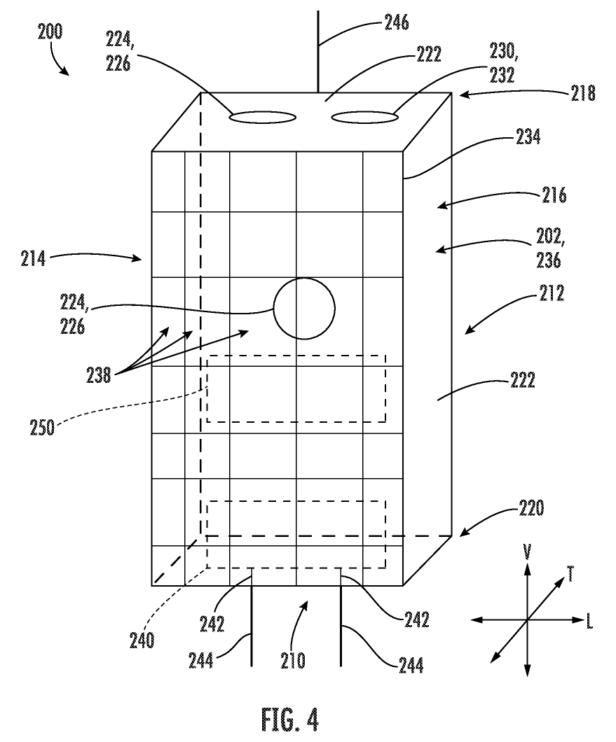

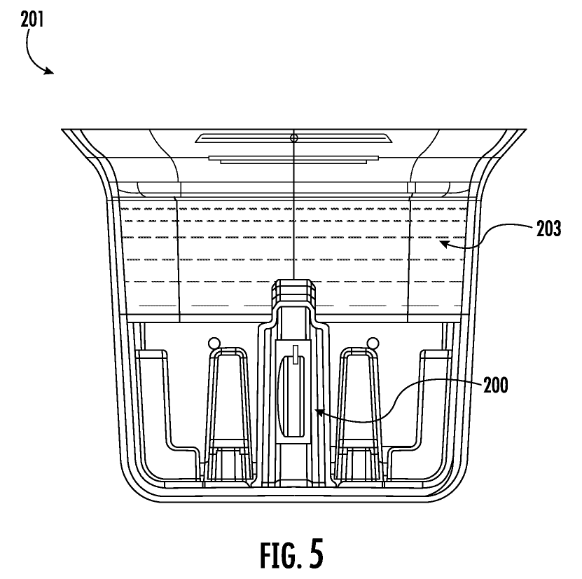

Referring now to FIGS. 4 and 5, various views of a measuring device 200 to be utilized with a cooking appliance are provided according to exemplary embodiments of the present disclosure. Specifically, FIG. 4 provides a sectional view of measuring device 200 and components therein. FIG. 5 provides a sectional view of a food container 201 and measuring device 200 positioned within food container 201.

The measuring device 200 may be configured as a measuring device that may be utilized with cooking appliance 100 to measure one or more various parameters associated with cooking appliance 100. For example, measuring device 200 may be used to measure the temperature of food contents within food container 201 while food container 201 is positioned within cooking chamber 104 of cooking appliance 100. In some embodiments, measuring device 200 may be configured as a stand-alone measuring device in that it may be utilized with various cooking appliances other than cooking appliance 100 such as a conventional oven, convection oven, air fryer, and/or the like. For example, measuring device 200 may not be physically connected to circuitry of the cooking appliance 100. However, it should be appreciated that measuring device 200 may not be configured as a stand-alone measuring device, e.g., measuring device 200 may be physically connected to the circuitry of cooking appliance 100 and may also be mounted to cooking appliance 100, such as within cooking chamber 104.

As illustrated in FIG. 4, measuring device 200 may include a housing 202 for housing various internal components of measuring device 200 within, such as internal electrical components. The housing 202 of measuring device 200 may generally extend between a forward side 210 and a rear side 212 in the transverse direction T, a first (left) side 214 and a second (right) side 216 in the lateral direction L, and top side 218 and a bottom side 220 in the vertical direction V. Additionally, housing 202 may include one or more sidewalls 222. The sidewall(s) 222 may collectively define a rectangularly-shaped perimeter of housing 202. However, in other embodiments, sidewall(s) 222 may define any other polygonal-shaped perimeter of housing 202, such as a cylindrical shape.

Additionally, measuring device 200 may include one or more sensors for measuring the various parameters associated with the operation of a cooking appliance, such as cooking appliance 100. In some embodiments, measuring device 200 may include a first sensor 224. As illustrated in FIG. 4, first sensor 224 may be positioned within housing 202. The first sensor 224 may be configured to measure one or more parameters associated with the operation of cooking appliance 100. For example, in some embodiments, first sensor 224 may be configured as a temperature sensor 226, such as an infrared thermometer for contactless temperature measurements, a probe thermometer including a probe insertable within the food content for measuring temperature, and/or the like. However, it should be appreciated that first sensor 224 may be configured as any suitable type of sensor for measuring the various parameters associated with the operation of a cooking appliance.

The temperature sensor 226 of measuring device 200 may be configured to measure a temperature of food contents, such as during a heating operation of a cooking appliance, such as cooking appliance 100. The food contents may correspond to liquid-based food contents such as soup, coffee, tea, and/or the like, and/or solid food contents, such as steak, eggs, and/or the like, immersed and heated within a fluid, e.g., during a sous vide cooking process. In this respect, as illustrated in FIG. 5, measuring device 200 may be positioned within food container 201 so that the temperature of food contents within food container 201, such as a volume of water 203, may be measured. In some embodiments, measuring device 200 may be at least partially submerged in the liquid/fluid within food container 201 such that temperature sensor 226 is also submerged in the liquid/fluid within food container 201. In this respect, the temperature of the food contents within the food container 201 may be measured directly, such as by controller 118. As such, in optional embodiments, temperature sensor 226 may include a probe (not shown) that may be inserted within the liquid/fluid within food container 201 so that the temperature of the food contents within the food container 201 may be measured directly.

Furthermore, in addition to first sensor 224, measuring device 200 may include a second sensor 230. As illustrated in FIG. 4, second sensor 230 may be positioned on housing 202 externally of measuring device 200. However, it should be appreciated that second sensor 230 may be positioned within housing 202.

In some exemplary embodiments, the second sensor 230 of measuring device 200 may be configured as a fluid sensor. As such, second sensor 230 may be configured to measure one or more parameters associated with a presence of fluid and/or a level of fluid within a container, such as food container 201. Specifically, in some exemplary embodiments, second sensor 230 may be configured as an ultrasonic fluid sensor 232. The ultrasonic fluid sensor 232 may emit sound waves, such as at the fluid within food container 201, and receive and analyze reflected sound waves, such as the speed of the reflected sound waves. However, it should be appreciated that ultrasonic fluid sensor 232 may analyze any other suitable property of the emitted and/or reflected sound waves, such as the time of flight or time taken to receive a reflected sound wave once the emitted sound wave has been emitted, frequency, and/or the like. The speed of the reflected sound waves may be indicative of the presence of the fluid and/or the level of the fluid within food container 201. The speed of the reflected sound analyzed by ultrasonic fluid sensor 232 may be used by controller 118 of the cooking appliance 100 to detect the presence of the fluid and/or to determine the fluid level within food container 201. The fluid may correspond to fluid (e.g., water) within which solid food contents are cooked such as steak, eggs, and/or the like, immersed and heated within a fluid, e.g., during a sous vide cooking process and/or may correspond to liquid-based food contents such as soup, coffee, tea, and/or the like.

It should be appreciated that the fluid sensor may correspond to any suitable fluid sensor configured to generate data indicative of the fluid within a food container, such as food container 201. For example, in some embodiments, the fluid sensor may be configured as a pressure transducer configured to measure pressure of the fluid within fluid container 201, a float switch configured to move in response to submerging the fluid sensor into the fluid within food container 201, an optical sensor, e.g., laser, an imaging device, e.g., camera, and/or the like.

Additionally, in some embodiments, second sensor 230 may be positioned relative to food container 201 such that second sensor 230 has a detection zone 233 of an entirety of a surface 235 of the fluid within food container 201 (FIG. 2). For example, measuring device 200 and, thus, second sensor 230, may be positioned within cooking chamber 104 of cooking appliance 100 above food container 201, e.g., mounted to a ceiling within cooking chamber 104. In this respect, second sensor 230 may have a detection zone 233 of the entirety of surface 235 of the fluid within food container 201.

As illustrated in FIG. 5, in some embodiments, measuring device 200 may be positioned outside of the fluid within food container 201 so that second sensor 230 is not positioned within the fluid within food container 201. However, in some other embodiments, measuring device 200 may be at least partially submerged in the fluid within food container 201 so that second sensor 230 is also submerged in the fluid within food container 201.

Furthermore, as illustrated in FIG. 4, in some embodiments, measuring device 200 may include a fluid seal 234, such as a rubber gasket. The fluid seal 234 may enclose housing 202 of measuring device 200, such as an outer perimeter of housing 202. As briefly described above, housing 202 may house or contain various internal components of measuring device 200 within. For example, housing may house or container various internal electrical components of measuring device 200, such as first sensor 224. The fluid seal 234 may inhibit or prevent fluid from entering housing 202 and, thus, inhibit or prevent fluid from damaging or disrupting the operation of the internal electrical components of measuring device 200.

Additionally, in some embodiments, housing 202 of measuring device 200 is configured as a metal barrier 236. The metal barrier 236 may be utilized to shield the internal components of measuring device 200 from the microwaves emitted by cooking appliance 100. In this respect, metal barrier 236 may at least partially include or be at least partially made up of a type of metal useful for shielding the internal components of measuring device 200 from the emitted microwaves. For example, metal barrier 236 may at least partially include or be at least partially made up of copper or a copper alloy.

Moreover, as illustrated in FIG. 4, in some embodiments, a plurality of openings 238 may be defined through metal barrier 236. In this respect, for example, metal barrier 236 may correspond to a cage structure, such as a Faraday cage. As such, first sensor 224 may be configured to measure the parameters associated with the heating operation of cooking appliance 100, such as the temperature of the food contents of food container 201, while metal barrier 236 shields first sensor 224 and other internal components of measuring device 200. Additionally, or alternatively, in embodiments in which ultrasonic fluid sensor 232 or other second sensor 230 is positioned within housing 202, ultrasonic fluid sensor 232 is configured to emit the sound waves through plurality of openings 238 of metal barrier 236 into fluid, such as the fluid within food container 201, and analyze the speed of the reflected sound waves that are reflected through plurality of openings 238.

Furthermore, as illustrated in FIG. 4, in some embodiments, measuring device 200 may include a chargeable battery 240. The chargeable battery 240 may be positioned within housing 202 of measuring device 200 and configured to provide electrical power to measuring device 200, such as to all components of measuring device 200 that operate using electrical power (e.g., first sensor 224, second sensor 230). As such, measuring device 200 may also include a charging interface or port 242. For example, the charging port 242 may include a pair of charging connectors or pins 244 which, as illustrated in FIG. 4, protrude externally from the bottom of measuring device 200. The charging port 242 may be operatively/electrically connectable to an external charging device (not shown) for charging chargeable battery 240 of measuring device 200. In this respect, charging port 242 is operatively/electrically connected to chargeable battery 240 for transferring electrical energy from the external charging device to chargeable battery 240.

Additionally, in some embodiments, measuring device 200 may include a controller 250. Controller 250 of measuring device 200 may include one or more processor(s) and one or more memory device(s). The processor(s) of controller 250 may be any suitable processing device, such as a microprocessor, microcontroller, integrated circuit, or other suitable processing device. The memory device(s) of controller 250 may include any suitable computing system or media, including, but not limited to, non-transitory computer-readable media, RAM, ROM, hard drives, flash drives, or other memory devices. The memory device(s) of controller 250 may store information accessible by the processor(s) of controller 250 including instructions that may be executed by the processor(s) of controller 250.

Furthermore, controller 250 of measuring device 200 may be configured to initiate a control action or command associated with wirelessly connecting measuring device 200 with/to cooking appliance 100, such as to controller 118 of cooking appliance 100. For example, controller 250 of measuring device 200 may be configured to initiate a control action/command to wirelessly connect measuring device 200 to cooking appliance 100 via external communication system 150. Additionally, or alternatively, in some embodiments, measuring device 200 may include an antenna 246 for wirelessly transmitting data to and/or wirelessly receiving data from controller 118 of cooking appliance 100. For example, antenna 246 may be configured to transmit data, such as the measured parameter(s) from first sensor 224 and/or second sensor 230, to controller 118. Additionally, or alternatively, in some embodiments, controller 250 of measuring device 200 may be configured to initiate a control action associated with wirelessly connecting the measuring device 200 to a remote user device (not shown), such as a smartphone or a tablet. For example, controller 250 of measuring device 200 may be configured to initiate a control action to wirelessly connect measuring device 200 to the remote user device via external communication system 150. In this respect, measuring device 200 may transmit the measured parameter(s) from first sensor 224 and/or second sensor 230 to the remote user device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A measuring device for a cooking appliance, comprising:
a housing configured to house one or more internal electronic components of the measuring device;
a first sensor positioned within the housing and configured to measure one or more parameters associated with a heating operation of the cooking appliance; and
an ultrasonic fluid sensor, the ultrasonic fluid sensor positioned on or within the housing and configured to emit sound waves at fluid within a food container and analyze a speed of reflected sound waves, the food container configured for heating by the cooking appliance, the speed of the reflected sound waves indicative of a presence or a level of the fluid within the food container.

2. The measuring device of claim 1, wherein:
the measuring device is positioned above the food container within a cooking chamber of the cooking appliance such that an entire surface of the fluid within the food container is within a detection zone of the fluid sensor.

3. The measuring device of claim 1, wherein:
the first sensor is configured as a temperature sensor, the temperature sensor configured to measure a temperature of contents within the food container.

4. The measuring device of claim 1, wherein the measuring device comprises a controller, the controller configured to initiate a control action associated with wirelessly connecting the measuring device to the cooking appliance.

5. The measuring device of claim 1, wherein the measuring device comprises an antenna, the antenna configured to transmit the one or more measured parameters from the first sensor or the ultrasonic fluid sensor, via a wireless connection, to the controller of the cooking appliance.

6. The measuring device of claim 1, wherein the measuring device further comprises the one or more internal electronic components within the housing of the measuring device and a fluid seal enclosing the housing of the measuring device, wherein the fluid seal inhibits the fluid from entering the measuring device.

7. The measuring device of claim 1, wherein the measuring device further comprises the one or more internal electronic components within the housing of the measuring device, wherein the housing of the measuring device is a metal barrier, wherein the metal barrier shields the one or more internal electronic components of the measuring device from microwave radiation within the cooking appliance.

8. The measuring device of claim 7, wherein a plurality of openings are defined within the metal barrier, whereby the first sensor is configured to measure the one or more parameters associated with the heating operation of the cooking appliance through the plurality of openings, or the ultrasonic fluid sensor is configured to emit the sound waves at the fluid within the food container and analyze the speed of the reflected sound waves through the plurality of openings.

9. A measuring device for a cooking appliance, comprising:
a housing configured to house one or more internal electronic components of the measuring device;
a first sensor positioned within the housing and configured to measure one or more parameters associated with a heating operation of the cooking appliance, the first sensor at least partially submerged in fluid within a food container; and
a second sensor configured as a fluid sensor, the fluid sensor positioned on or within the housing and configured to measure one or more parameters associated with a presence or level of the fluid within the food container, the food container configured for heating by the cooking appliance.

10. The measuring device of claim 9, wherein:
the measuring device is positioned above the food container within a cooking chamber of the cooking appliance such that an entire surface of the fluid within the food container is within a detection zone of the fluid sensor.

11. The measuring device of claim 9, wherein:
the first sensor is configured as a temperature sensor, the temperature sensor configured to measure a temperature of contents within the food container.

12. The measuring device of claim 9, wherein the fluid sensor of the measuring device is configured as an ultrasonic fluid sensor, the ultrasonic fluid sensor configured to emit sound waves at fluid within the food container and analyze a speed of reflected sound waves.

13. The measuring device of claim 9, wherein the measuring device comprises a controller, the controller configured to initiate a control action associated with wirelessly connecting the measuring device to the cooking appliance.

14. The measuring device of claim 9, wherein the measuring device comprises an antenna, the antenna configured to transmit the one or more measured parameters from the first sensor or the fluid sensor, via a wireless connection, to the controller of the cooking appliance.

15. The measuring device of claim 9, wherein the measuring device further comprises the one or more internal electronic components within the housing of the measuring device and a fluid seal enclosing the housing of the measuring device, wherein the fluid seal inhibits fluid from entering the measuring device.

16. The measuring device of claim 9, wherein the measuring device further comprises the one or more internal electronic components within the housing of the measuring device, wherein the housing of the measuring device is a metal barrier, wherein the metal barrier shields the one or more internal electronic components of the measuring device from microwave radiation within the cooking appliance.

17. The measuring device of claim 16, wherein a plurality of openings are defined within the metal barrier, whereby the first sensor is configured to measure the one or more parameters associated with the heating operation of the cooking appliance through the plurality of openings, or the fluid sensor is configured to measure the one or more parameters associated with the presence or the level of the fluid within the food container through the plurality of openings.

18. The measuring device of claim 9, wherein the measuring device comprises a controller, the controller configured to initiate a control action associated with wirelessly connecting the measuring device to a remote user device.

19. The measuring device of claim 18, wherein the measuring device is configured to transmit the one or more measured parameters, via a wireless connection, from the first sensor or the fluid sensor to the remote user device.

20. A measuring device for a cooking appliance, comprising:
a first sensor configured to measure one or more parameters associated with a heating operation of the cooking appliance, the first sensor at least partially submerged in fluid within a food container; and
a second sensor configured as a fluid sensor, the fluid sensor configured to measure one or more parameters associated with a presence or level of the fluid within the food container, the food container configured for heating by the cooking appliance.
